(19) United States
(12) Patent Application Publication
(10) Pub. No.: US 2026/0088520 A1
(43) Pub. Date: Mar. 26, 2026

(54) Dual Polarization Dipole Antenna

(71) Applicant: Emplus Technologies, Inc., Taipei City (TW)

(72) Inventor: Shih-Ying Chao, Taipei (TW)

(73) Assignee: Emplus Technologies, Inc., Taipei City (TW)

(21) Appl. No.: 19/406,934

(22) Filed: Dec. 3, 2025

Related U.S. Application Data
(62) Division of application No. 18/307,011, filed on Apr. 26, 2023, now Pat. No. 12,519,251.

(30) Foreign Application Priority Data
Apr. 27, 2022 (TW) 111116093
Apr. 27, 2022 (TW) 111116094

(51) Int. Cl. H01Q 21/26; H01Q 9/16

(52) U.S. Cl. CPC H01Q 21/26; H01Q 9/16

(57) ABSTRACT

A dual polarization antenna device includes a first input terminal, a first arc wire, a second arc wire, a third arc wire, and a fourth arc wire. A first terminal of the first arc wire transmits and receives an output data signal along a first direction. A second terminal of the second arc wire transmits and receives the output data signal along a second direction. The first input terminal forms a first tangent line along the first arc wire, the first input terminal forms a second tangent line along the second arc wire, and the first tangent line and the second tangent line intersect each other at an angle. A third terminal of the third arc wire transmits and receives the output data signal along a third direction. A fourth terminal of the fourth arc wire transmits and receives the output data signal along a fourth direction.

### CROSS-REFERENCES TO RELATED APPLICATIONS

This application claims priority to Taiwan Application Serial Number 111116093, filed Apr. 27, 2022, which is herein incorporated by reference in its entirety, and claims priority to Taiwan Application Serial Number 111116094, filed Apr. 27, 2022, which is herein incorporated by reference in its entirety.

This application is a divisional of U.S. application Ser. No. 18/307,011, filed on Apr. 26, 2023, which is still pending. The present application claims subject matter disclosed but not claimed in the parent application, particularly the invention designated as Invention II in the Restriction Requirement dated Dec. 11, 2024.

### BACKGROUND

### Field of Invention

The present invention relates to an antenna device. More particularly, the present invention relates to a dual polarization antenna device.

### Description of Related Art

The single-polarized antennas used today often have the problem of insufficient polarization coverage. Vertically polarized zero-coverage areas are prone to occur, and limits the area where the signal can be received.

### SUMMARY

The present disclosure provides a dual polarization antenna device. The dual polarization antenna device includes a first input terminal, a first arc wire, a second arc wire, a third arc wire, and a fourth arc wire. The first input terminal is configured to receive an input data signal. The first arc wire is located at a front of a substrate and coupled to the first input terminal. A first terminal of the first arc wire transmits and receives an output data signal along a first direction. The second arc wire is located at the front of the substrate and coupled to the first input terminal. A second terminal of the second arc wire transmits and receives the output data signal along a second direction. The first input terminal forms a first tangent line along the first arc wire, the first input terminal forms a second tangent line along the second arc wire, and the first tangent line and the second tangent line intersect each other at an angle. The third arc wire is located at a rear of the substrate and coupled to the first input terminal. A third terminal of the third arc wire transmits and receives the output data signal along a third direction. The fourth arc wire is located at the rear of the substrate and coupled to the first input terminal. A fourth terminal of the fourth arc wire transmits and receives the output data signal along a fourth direction. The first input terminal forms a third tangent line along the third arc wire, the first input terminal forms a fourth tangent line along the fourth arc wire, and the third tangent line and the fourth tangent line intersect each other at the angle. The first direction is parallel to the third direction, the second direction is parallel to the fourth direction, and the first direction is perpendicular to the second direction.

The present disclosure provides a dual polarization antenna device. The dual polarization antenna device includes an input terminal, a first antenna, and a second antenna. The first antenna includes a first sub antenna, a second sub antenna, a fifth sub antenna and a sixth sub antenna. The second antenna includes a third sub antenna, a fourth sub antenna, a seventh sub antenna and an eighth sub antenna. The input terminal is configured to receive a first input signal and/or a second input signal. The first sub antenna is located at a front of a substrate and coupled to the input terminal. A first terminal of the first sub antenna transmits and receives a first output signal along a first direction according to the first input signal. The second sub antenna is located at the front of the substrate and coupled to the input terminal. A second terminal of the second sub antenna transmits and receives the first output signal along a second direction according to the first input signal. The third sub antenna is located at the front of the substrate and coupled to the input terminal. A third terminal of the third sub antenna transmits and receives a second output signal along a third direction according to the second input signal. The fourth sub antenna is located at the front of the substrate and coupled to the input terminal. A fourth terminal of the fourth sub antenna transmits and receives the second output signal along a fourth direction according to the second input signal. The first direction is perpendicular to the second direction, and the third direction is perpendicular to the fourth direction. The fifth sub antenna is located at a rear of the substrate and coupled to the input terminal. A fifth terminal of the fifth sub antenna transmits and receives the first output signal along a fifth direction according to the first input signal. The sixth sub antenna is located at the rear of the substrate and coupled to the input terminal. A sixth terminal of the sixth sub antenna transmits and receives the first output signal along a sixth direction according to the first input signal. The seventh sub antenna is located at the rear of the substrate and coupled to the input terminal. A seventh terminal of the seventh sub antenna transmits and receives the second output signal along a seventh direction according to the second input signal. The eighth sub antenna is located at the rear of the substrate and coupled to the input terminal. The eighth sub antenna is located at the rear of the substrate and coupled to the input terminal. An eighth sub terminal of the eighth antenna transmits and receives the second output signal according to the second input signal. The fifth direction is parallel to the first direction and the sixth direction is parallel to the second direction. The seventh direction is parallel to the third direction, and the eighth direction is parallel to the fourth direction.

Therefore, based on the technical content of the present disclosure, the dual polarization antenna device shown in the embodiment of the present disclosure can use the technology of dual polarization transmit and receive signals to improve the effectiveness of the signal transmit and receive area.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a structural diagram of a front of a dual polarization antenna device according to an embodiment of the present disclosure.

FIG. 2 is a structural diagram of a rear of a dual polarization antenna device according to an embodiment of the present disclosure.

FIG. 3 is a structural diagram of a plurality of dual polarization antenna devices according to an embodiment of the present disclosure.

FIG. 4 is a structural diagram of a front of a plurality of dual polarization antenna devices according to an embodiment of the present disclosure.

FIG. 5 is a structural diagram of a rear of a plurality of dual polarization antenna devices according to an embodiment of the present disclosure.

FIG. 6 is a structural diagram of a plurality of dual polarization antenna devices according to an embodiment of the present disclosure.

FIG. 7 is a structural diagram of a dual polarization antenna device according to an embodiment of the present disclosure.

FIG. 8 is a structural diagram of a front of a dual polarization antenna device according to an embodiment of the present disclosure.

FIG. 9 is a structural diagram of a rear of a dual polarization antenna device according to an embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The embodiments below are described in detail with the accompanying drawings, but the examples provided are not intended to limit the scope of the disclosure covered by the description. The structure and operation are not intended to limit the execution order. Any structure regrouped by elements, which has an equal effect, is covered by the scope of the present disclosure.

Various embodiments of the present technology are discussed in detail below with figures. It should be understood that the details should not limit the present disclosure. In other words, in some embodiments of the present disclosure, the details are not necessary. In addition, for simplification of figures, some known and commonly used structures and elements are illustrated simply in figures.

In the present disclosure, “connected” or “coupled” may refer to “electrically connected” or “electrically coupled.” “Connected” or “coupled” may also refer to operations or actions between two or more elements.

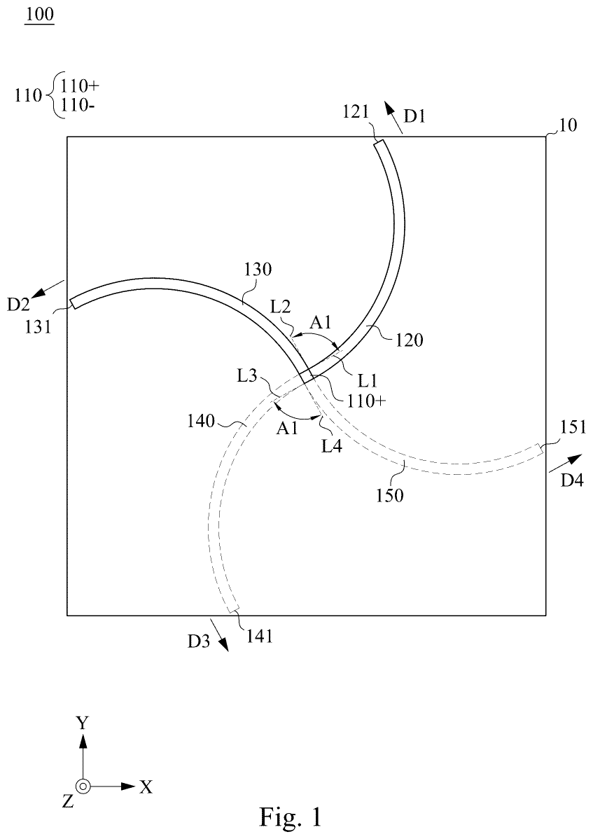

FIG. 1 is a structural diagram of a front of a dual polarization antenna device according to an embodiment of the present disclosure. As shown in the figure, the dual polarization antenna device 100 includes a first input terminal 110, a first arc wire 120, a second arc wire 130, a third arc wire 140, and a fourth arc wire 150. In positional relationship, the first arc wire 120 and the second arc wire 130 are located at a front of the substrate 10, the third arc wire 140 and the fourth arc wire 150 are located at a rear of the substrate 10. In connection relationship, the first arc wire 120 is coupled to the first input terminal 110, the second arc wire 130 is coupled to the first input terminal 110, the third arc wire 140 is coupled to the first input terminal 110, and the fourth arc wire 150 is coupled to the first input terminal 110. In some embodiments, the first input terminal 110 can include an input terminal 110+ and an input terminal 110−, where in connection relationship, the first arc wire 120 is coupled to the input terminal 110+, the second arc wire 130 is coupled to the input terminal 110+, the third arc wire 140 is coupled to the input terminal 110−, and the fourth arc wire 150 is coupled to the input terminal 110−, but the present disclosure is not limited to such embodiments.

In order to use the technology of dual polarization transmit and receive signals to improve the effectiveness of the signal transmit and receive area, the present disclosure provides the dual polarization antenna device 100 in FIG. 1, and the detailed operations of the dual polarization antenna device 100 is as shown below.

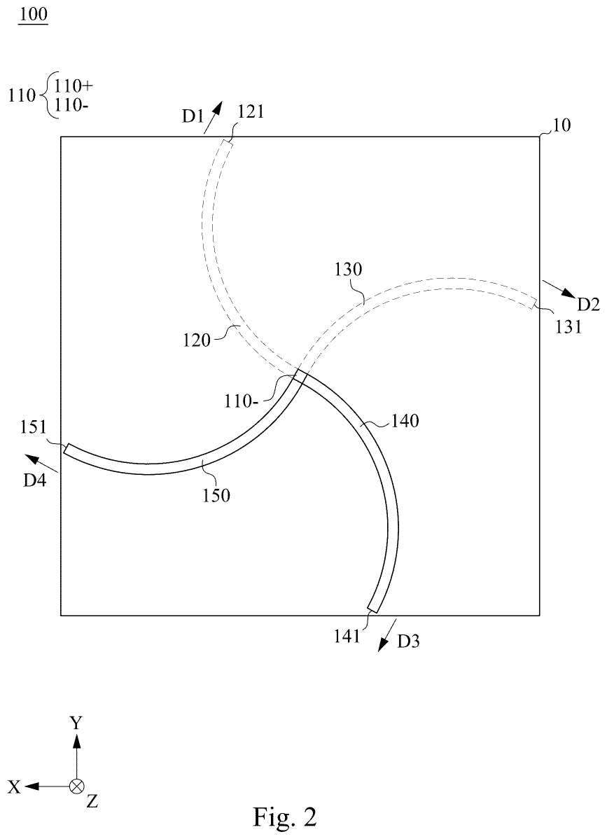

FIG. 2 is a structural diagram of a rear of a dual polarization antenna device according to one embodiment of the present disclosure. Referring to FIG. 1 and FIG. 2, the first input terminal 110 (such as the input terminal 110+, 110−) is configured to receive an input data signal. A first terminal 121 of the first arc wire 120 transmits and receives an output data signal along a first direction D1. For example, an input data signal can have a corresponding relationship with the output data signal, the input signal can be converted into an output data signal through the first arc wire 120, and the first terminal 121 of the first arc wire 120 transmits this output data signal along the first direction D1. Moreover, the first terminal 121 of the first arc wire 120 can receive the output data signal along the first direction D1, and this output data signal can be converted into the input data signal through the first arc wire 120, but the present disclosure is not limited to the embodiment.

Then, a second terminal 131 of the second arc wire 130 transmits and receives the output data signal along a second direction D2, wherein the first input terminal 110 (such as the input terminal 110+) forms a first tangent line L1 along the first arc wire 120, the first input terminal 110 (such as the input terminal 110+) forms a second tangent line L2 along the second arc wire 130, and the first tangent line L1 and the second tangent line L2 intersect each other at an angle A1. A third terminal 141 of the third arc wire 140 transmits and receives the output data signal along a third direction D3. A fourth terminal 151 of the fourth arc wire 150 transmits and receives the output data signal along a fourth direction D4, wherein the first input terminal 110 (such as the input terminal 110−) forms a third tangent line L3 along the third arc wire 140, the first input terminal 110 (such as the input terminal 110−) forms a fourth tangent line L4 along the fourth arc wire 150, and the third tangent line L3 and the fourth tangent line L4 intersect each other at the angle A1, wherein the first direction D1 is parallel to the third direction D3, the second direction D2 is parallel to the fourth direction D4, and the first direction D1 is perpendicular to the second direction D2.

For example, a conversion relationship between the input signal and the output data signal through the second arc wire 130, third arc wire 140, or fourth arc wire 150 can be similar to the conversion relationship between the input signal and the output data signal through the first arc wire 120, and so will be omitted herein for the sake of brevity. Moreover, the first tangent line L1 and the second tangent line L2 can intersect each other at the angle A1, the third tangent line L3 and the fourth tangent line L4 can intersect each other at the angle A1, and the angle A1 can be 90 degrees. The main purpose is to ensure that the polarization directions of the output data signal sent by the first arc wire 120, second arc wire 130, third arc wire 140, and fourth arc wire 150 are vertical or horizontal to each other, so as to improve the transmit and receive area of the output data signal, but the present disclosure is not limited to such embodiment.

Additionally, the first direction D1 can be parallel to the third direction D3, the second direction D2 can be parallel to the fourth direction D4, and the first direction D1 can be perpendicular to the second direction D2. The first direction D1, the second direction D2, the third direction D3, and the fourth direction D4 can all be parallel to the substrate 10.

In an embodiment, a shape of the first arc wire 120, a shape of the second arc wire 130, a shape of the third arc wire 140, and a shape of the fourth arc wire 150 are the same. For example, the first arc wire 120, the second arc wire 130, the third arc wire 140, and the fourth arc wire 150 can have the same appearance or shape as each other, and the shape can generally be a one-dimensional, a two-dimensional, or a three-dimensional shape, but the present disclosure is not limited to such embodiment.

In an embodiment, the shape of the first arc wire 120, the shape of the second arc wire 130, the shape of the third arc wire 140, and the shape of the fourth arc wire 150 each include a quarter arc wire of a round. For example, the round can be a shape that follows an arc length equal to 2πr, the round can be divided into four quarter arc wires, and one of the four quarter arc wires can be used as the first arc wire 120, the second arc wire 130, the third arc wire 140, or the fourth arc wire 150. In other words, the first arc wire 120 can be the quarter arc wire, the second arc wire 130 can be the quarter arc wire, the third arc wire 140 can be the quarter arc wire, and the fourth arc wire 150 can be the quarter arc wire, but the present disclosure is not limited to such embodiment.

In one embodiment, a first length of the first arc wire 120, a second length of the second arc wire 130, a third length of the third arc wire 140, and a fourth length of the fourth arc wire 150 are identical to each other. For example, an arc length of the first arc wire 120 can be 3.1 cm (centimeter), and an arc length of the second arc wire 130, an arc length of the third arc wire 140, and an arc length of the fourth arc wire 150 can all be 3.1 cm, but the present disclosure is not limited to such embodiment.

In one embodiment, the first length of the first arc wire 120, the second length of the second arc wire 130, the third length of the third arc wire 140, and the fourth length of the fourth arc wire 150 each comprises a quarter wavelength length of the output data signal. For example, the first length, the second length, the third length, and the fourth length can be equal, and follow the following formula:

$$cl = \frac{1}{4} λ . \qquad formula 1$$

$$λ = \frac{c}{f} . \qquad formula 2$$

In the above formula 1, cl is the arc length (in centimeters, cm), and λ is a wavelength (in centimeters, cm). In the above formula 2, λ is the wavelength (in centimeters, cm), c is a speed of light (in meters per second, m/s), f is a frequency (in Hertz, Hz).

A Table 1 can be obtained according to the above formula 1 and formula 2, as shown below.

TABLE 1

| | 2 G antenna | 5 G antenna | 2.4 G antenna |
|---|---|---|---|
| the speed of light (m/s) | 3 × 10⁸ | 3 × 10⁸ | 3 × 10⁸ |
| the frequency (Hz) | 2 × 10⁹ | 5 × 10⁹ | 2.4 × 10⁹ |
| the wavelength (cm) | 15 | 6 | 12.5 |
| the arc length (cm) | 3.75 | 1.5 | 3.125 |

The arc length shown in the Table 1 can be the first length of the first arc wire 120, the second length of the second arc wire 130, the third length of the third arc wire 140, or the fourth length the fourth arc wire 150, and the arc length can be 3.75, 1.5 or 3.125 cm, but the present disclosure is not limited to such embodiment.

In one embodiment, the angle A1 includes a 90 degree angle. For example, the angle A1 can be 70, 80, or 90 degrees, but the present disclosure is not limited to the embodiment. In some embodiments, the angle A1 (that is, a best implementation angle) in the present disclosure can be 90 degrees, but the present disclosure is not limited to such embodiment.

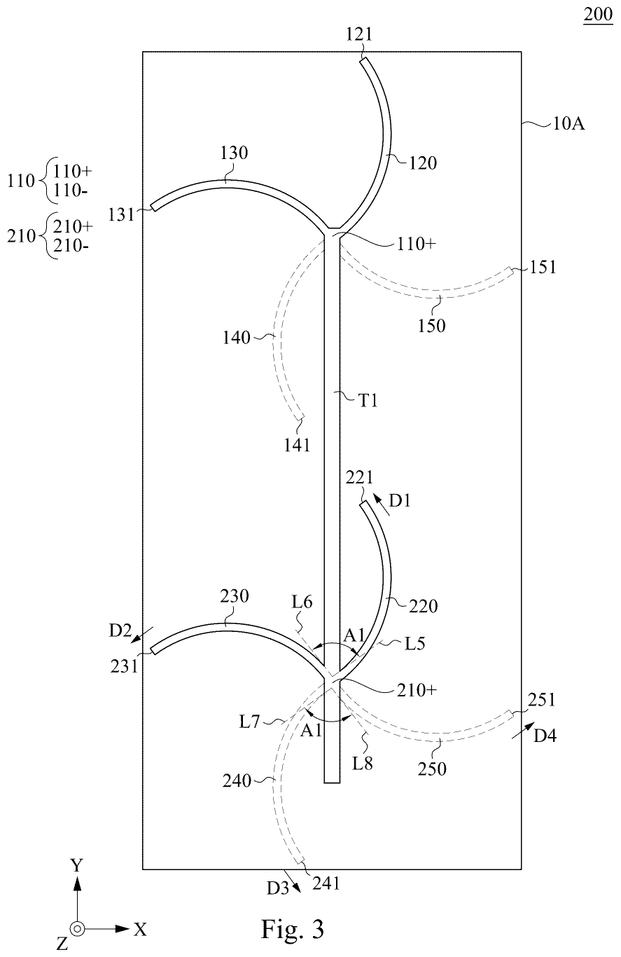

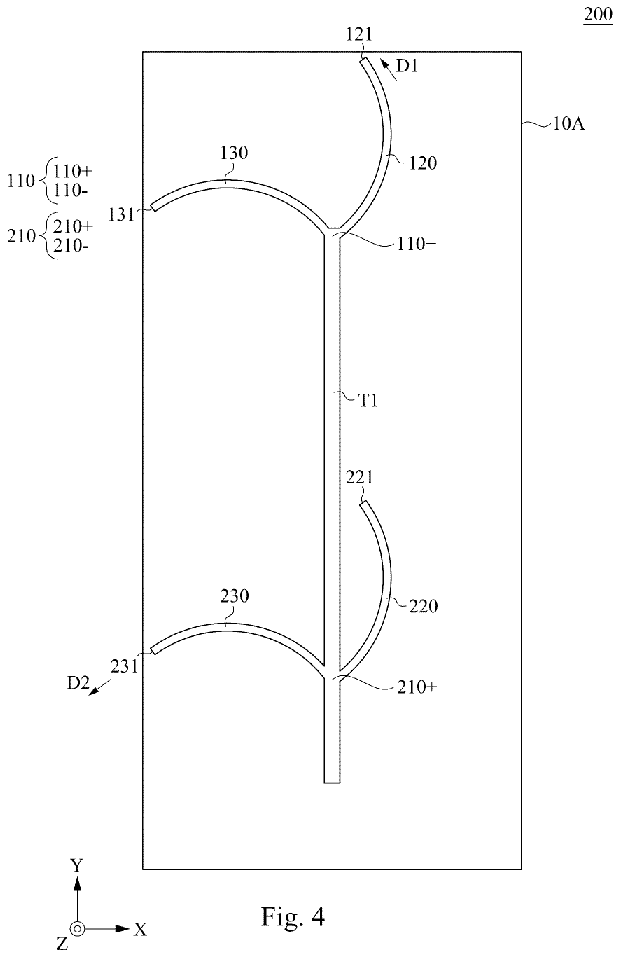

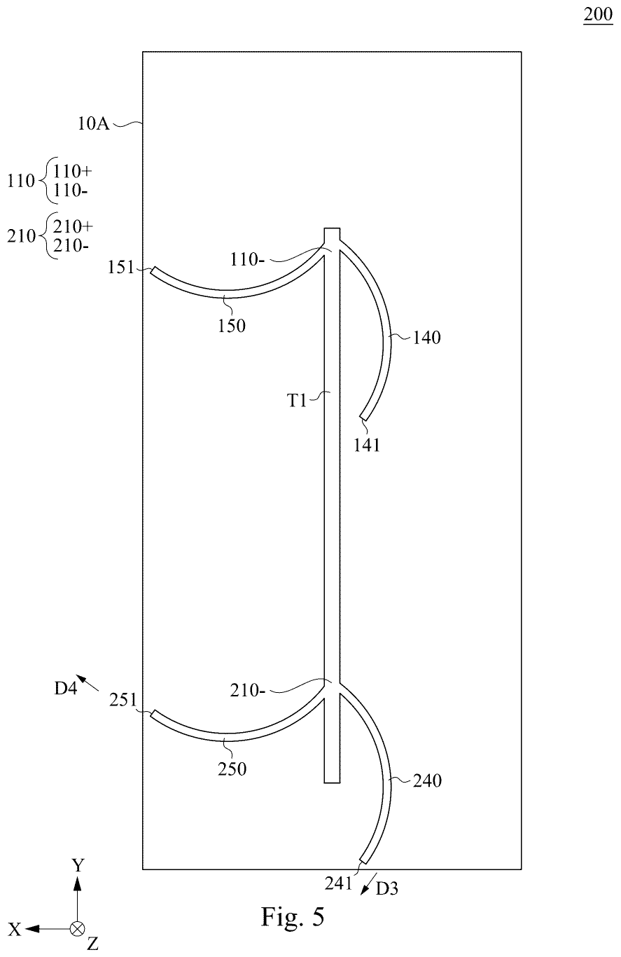

FIG. 3 is a structural diagram of a plurality of dual polarization antenna devices according to other embodiment of the present disclosure. As shown in the figure, the dual polarization antenna device 200 further includes a second input terminal 210, a transmitter T1, a fifth arc wire 220, a sixth arc wire 230, a seventh arc wire 240, and an eighth arc wire 250. In positional relationship, the fifth arc wire 220 and the sixth arc wire 230 are located at the front of the substrate 10A, and the seventh arc wire 240 and the eighth arc wire 250 are located at the rear of the substrate 10A. In connection relationship, transmitter T1 is connected through and coupled to the first input terminal 110 and the second input terminal 210, the fifth arc wire 220 is coupled to the second input terminal 210, the sixth arc wire 230 is coupled to the second input terminal 210, the seventh arc wire 240 is coupled to the second input terminal 210, and the eighth arc wire 250 is coupled to the second input terminal 210. In some embodiments, the second input terminal 210 includes the input terminal 210+ and the input terminal 210− (as shown in FIGS. 4 and 5). In connection relationship, the fifth arc wire 220 is coupled to the input terminal 210+, the sixth arc wire 230 is coupled to the input terminal 210+, the seventh arc wire 240 is coupled to the input terminal 210−, and the eighth arc wire 250 is coupled to the input terminal 210−, but the present disclosure is not limited to such embodiment.

In order to use the technology of dual polarization transmit and receive signals to improve the effectiveness of the signal transmit and receive area, the present disclosure provides the dual polarization antenna device 200 in FIG. 3, and the detailed operations of the dual polarization antenna device 200 is as shown below.

FIG. 4 is a structural diagram of a front of a plurality of dual polarization antenna devices according to an embodiment of the present disclosure. FIG. 5 is a structural diagram of a rear of a plurality of dual polarization antenna devices according to an embodiment of the present disclosure. Referring to FIG. 3 to FIG. 5, in one embodiment, the second input terminal 210 (such as the input terminal 210+, 210−) is configured to receive the input data signal. A fifth terminal 221 of the fifth arc wire 220 transmits and receives the output data signal along the first direction D1. A sixth terminal 231 of the sixth arc wire 230 transmits and receives the output data signal along the second direction D2, wherein the second input terminal 210 (such as the input terminal 210+) forms a fifth tangent line L5 along the fifth arc wire 220, the second input terminal 210 (such as the input terminal 210+) forms a sixth tangent line L6 along the sixth arc wire 230, and the fifth tangent line L5 and the sixth tangent line L6 intersect each other at the angle A1. A seventh terminal 241 of the seventh arc wire 240 transmits and receives the output data signal along the third direction D3. An eighth terminal 251 of the eighth arc wire 250 transmits and receives the output data signal along the fourth direction D4, the second input terminal 210 (such as the input terminal 210−) forms a seventh tangent line L7 along the seventh arc wire 240, the second input terminal 210 (such as the input terminal 210−) forms an eighth tangent line L8 along the eighth arc wire 250, and the seventh tangent line L7 and the eighth tangent line L8 intersect each other at the angle A1.

For example, a conversion relationship between the input signal and the output data signal through the fifth arc wire 220, the sixth arc wire 230, the seventh arc wire 240, or the eighth arc wire 250 can be similar to the conversion relationship between the input signal and the output data signal through the first arc wire 120 in FIG. 1, and thus it will be omitted herein for the sake of brevity. Moreover, the fifth tangent line L5 and the sixth tangent line L6 can intersect each other at the angle A1, the seventh tangent line L7 and the eighth tangent line L8 can intersect each other at the angle A1, and the angle A1 can be 90 degrees. The main purpose is to ensure that the polarization directions of the output data signal sent by the fifth arc wire 220, the sixth arc wire 230, the seventh arc wire 240, and the eighth arc wire 250 are vertical or horizontal to each other, so as to improve the transmit and receive area of the output data signal, but the present disclosure is not limited to such embodiment.

In an embodiment, the first arc wire 120 corresponds to the fifth arc wire 220, the second arc wire 130 corresponds to the sixth arc wire 230, the third arc wire 140 corresponds to the seventh arc wire 240, and the fourth arc wire 150 corresponds to the eighth arc wire 250, and the arc wires corresponding to each other (such as the first arc wire 120 and the fifth arc wire 220) can be used to transmit the output data signal in the same direction, but the present disclosure is not limited to such embodiment.

In an embodiment, the shape of the first arc wire 120, the shape of the second arc wire 130, the shape of the third arc wire 140, the shape of the fourth arc wire 150, a shape of the fifth arc wire 220, a shape of the sixth arc wire 230, a shape of the seventh arc wire 240, and a shape of the eighth arc wire 250 are the same. For example, the first arc wire 120, the second arc wire 130, the third arc wire 140, the fourth arc wire 150, the fifth arc wire 220, the sixth arc wire 230, the seventh arc wire 240, and the eighth arc wire 250 can have the same appearance or shape as each other, and the shape can generally refer to a one-dimensional, a two-dimensional, or a three-dimensional shape, but the present disclosure is not limited to such embodiment.

In an embodiment, the shape of the fifth arc wire 220, the shape of the sixth arc wire 230, the shape of the seventh arc wire 240, and the shape of the eighth arc wire 250 each include the quarter arc of the round. For example, the round can be a shape that follows an arc length equal to 2πr, the round can be divided into four quarter arc wire, and one of the four quarter arc wire can be used as the fifth arc wire 220, the sixth arc wire 230, the seventh arc wire 240, and the eighth arc wire 250. In other words, the fifth arc wire 220 can be the quarter arc wire, the sixth arc wire 230 can be the quarter arc wire, the seventh arc wire 240 can be the quarter arc wire, and the eighth arc wire 250 can be the quarter arc wire, but the present disclosure is not limited to such embodiment.

In an embodiment, a length of the quarter arc wire includes the quarter wavelength length of the output data signal. For example, a fifth length of the fifth arc wire 220, a sixth length of the sixth arc wire 230, a seventh length of the seventh arc wire 240, and an eighth length of the eighth arc wire 250 can be equal, and follow the above formula 1 and formula 2. Referring to the Table 1, the arc length in the Table 1 can be the fifth length, the sixth length, the seventh length, and the eighth length. The arc length can be 3.75, 1.5 or 3.125 cm, but the present disclosure is not limited to such embodiment.

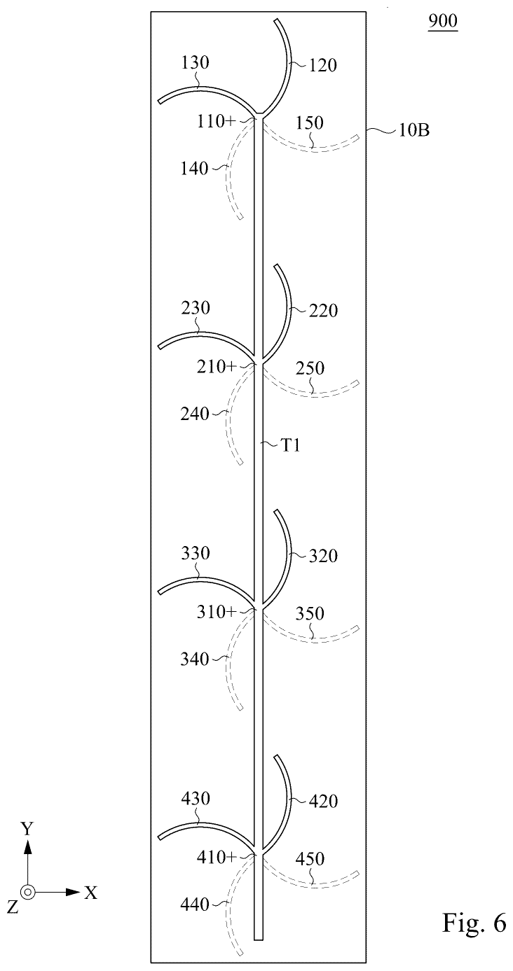

FIG. 6 is a structural diagram of a plurality of dual polarization antenna devices according to another embodiment of the present disclosure. As shown in the figure, the dual polarization antenna device 900 includes at least one of input terminal (such as the input terminal 110, 210, 310, and 410), at least one of first arc wire (such as the first arc wire 120, 220, 320, and 420), at least one of second arc wire (such as the second arc wire 130, 230, 330, and 430), at least one of third arc wire (such as the third arc wire 140, 240, 340, and 440), and at least one of fourth arc wire (such as the fourth arc wire 150, 250, 350, and 450). In positional relationship, the at least one of first arc wire (such as the first arc wire 120, 220, 320, and 420) and the at least one of second arc wire (such as the second arc wire 130, 230, 330, and 430) are located the front of the substrate 10B, the at least one of third arc wire (such as the third arc wire 140, 240, 340, and 440) and the at least one of fourth arc wire (such as the fourth arc wire 150, 250, 350, and 450) are located the rear of the substrate 10B. In connection relationship, the at least one of first arc wire (such as the first arc wire 120, 220, 320, and 420) is coupled to the at least one of input terminal (such as the input terminal 110+, 210+, 310+, and 410+), the at least one of second arc wire (such as the second arc wire 130, 230, 330, and 430) is coupled to the at least one of input terminal (such as the input terminal 110+, 210+, 310+, and 410+), the at least one of third arc wire (such as the third arc wire 140, 240, 340, and 440) is coupled to the at least one of input terminal (such as the input terminal 110−, 210−, 310−, and 410−), and the at least one of fourth arc wire (such as the fourth arc wire 150, 250, 350, and 450) is coupled to the at least one of input terminal (such as the input terminal 110−, 210−, 310−, and 410−).

In some embodiments, the at least one of input terminal 110 can have the input terminal 110+ and the input terminal 110−, the at least one of input terminal 210 can have the input terminal 210+ and the input terminal 210−, the at least one of input terminal 310 can have the input terminal 310+ and the input terminal 310−, and the at least one of input terminal 410 can have the input terminal 410+ and the input terminal 410−. In positional relationship, the input terminal 110+, 210+, 310+, and 410+ can be located at the front of the substrate 10B, the input terminal 110−, 210−, 310−, and 410− can be located at the rear of the substrate 10B, but the present disclosure is not limited to such embodiment.

It should be noted that the operation mode of the dual polarization antenna device 900 in FIG. 6 is similar to the operation mode of the dual polarization antenna device 100 in FIG. 1 and the dual polarization antenna device 200 in FIG. 3, and so it will be omitted herein for the sake of brevity.

It can be seen from the above embodiments that the present disclosure has the following advantages. The dual polarization antenna device shown in the embodiments of the present disclosure can use the technology of dual polarization transmit and receive signals to improve the effectiveness of the signal transmit and receive area.

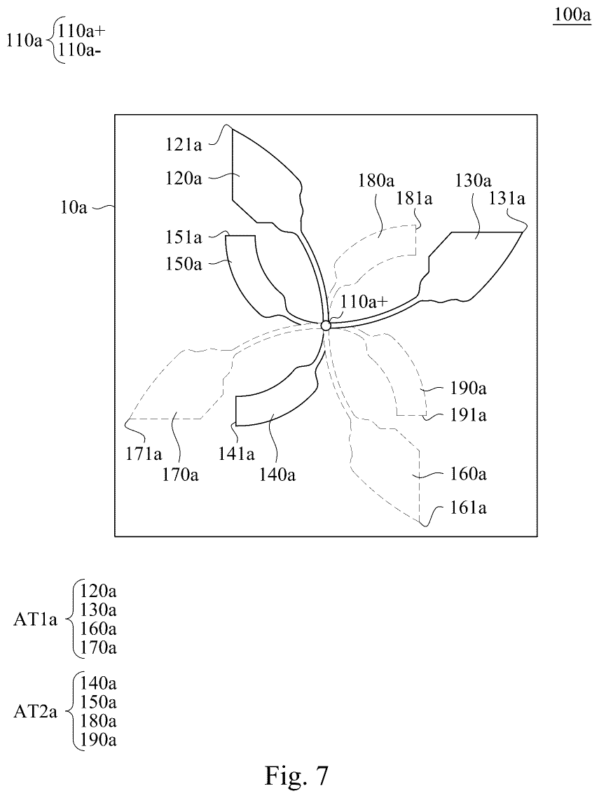

FIG. 7 is a structural diagram of a dual polarization antenna device according to an embodiment of the present disclosure. As shown in the figure, the dual polarization antenna device 100a includes an input terminal 110a, a first antenna AT1a, and a second antenna AT2a. The first antenna AT1a includes a first sub antenna 120a and a second sub antenna 130a. The second antenna AT2a includes a third sub antenna 140a and a fourth sub antenna 150a. In positional relationship, the first sub antenna 120a, the second sub antenna 130a, the third sub antenna 140a, and the fourth sub antenna 150a are all located at the front of the substrate 10a. In connection relationship, the first sub antenna 120a is coupled to the input terminal 110a, the second sub antenna 130a is coupled to the input terminal 110a, the third sub antenna 140a is coupled to the input terminal 110a, the fourth sub antenna 150a is coupled to the input terminal 110a. In some embodiments, the input terminal 110a can be composed of the input terminal 110a+ and the input terminal 110a−, in connection relationship, the first sub antenna 120a is coupled to the input terminal 110a+, the second sub antenna 130a is coupled to the input terminal 110a+, the third sub antenna 140a is coupled to the input terminal 110a+, the fourth sub antenna 150a is coupled to the input terminal 110a+, but the present disclosure is not limited to such embodiment.

In order to achieve the effect of outputting a plurality of output signals through a plurality of antenna structures, the present disclosure provides the dual polarization antenna device 100a in FIG. 7, and the detailed operations of the dual polarization antenna device 100a is as shown below.

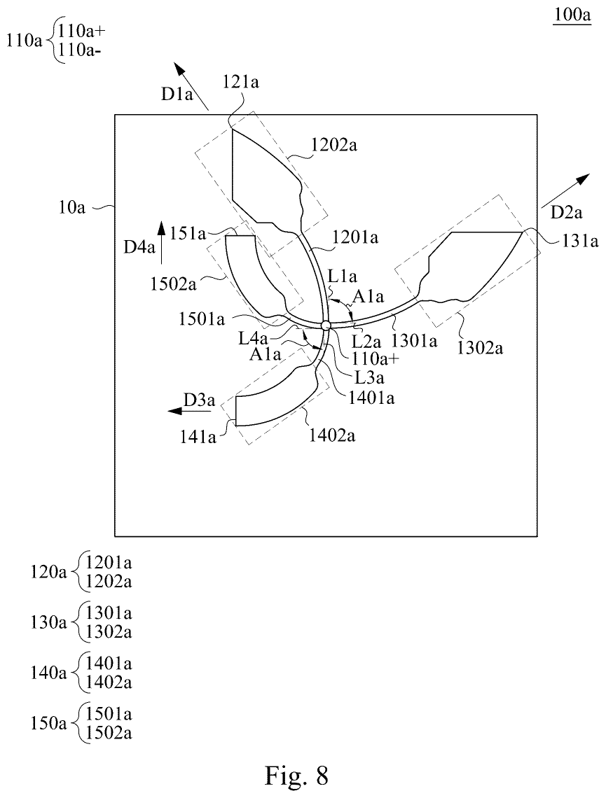

FIG. 8 is a structural diagram of a front of a dual polarization antenna device according to an embodiment of the present disclosure. Referring to FIG. 7 and FIG. 8, the input terminal 110a (such as the input terminal 110a+, 110a−) configured to receive a first input signal or a second input signal. A first terminal 121a of the first sub antenna 120a transmits and receives a first output signal along a first direction D1a according to the first input signal. For example, the first input signal can have a corresponding relationship with the first output signal, an input signal can be converted into an output signal through the first sub antenna 120a, and the first terminal 121a of the first sub antenna 120a transmits the first output signal along a first direction D1a. Besides, the first terminal 121a of first sub antenna 120a receives the first output signal along the first direction D1a, and the first output signal can be converted into the first input signal through the first sub antenna 120a, but the present disclosure is not limited to such embodiment.

A second terminal 131a of the second sub antenna 130a transmits and receives the first output signal along a second direction D2a according to the first input signal. A third terminal 141a of the third sub antenna 140a transmits and receives a second output signal along a third direction D3a according to the second input signal. A fourth terminal 151a of the fourth sub antenna 150a transmits and receives the second output signal along a fourth direction D4a according to the second input signal. The first direction D1a is perpendicular to the second direction D2a, and the third direction D3a is perpendicular to the fourth direction D4a.

For example, a conversion relationship between the first input signal and the first output signal through the second sub antenna 130a can be similar to the conversion relationship between the first input signal and the first output signal through the first sub antenna 120a. A conversion relationship between the second input signal and the second output signal through the third sub antenna 140a or the fourth sub antenna 150a can be similar to the conversion relationship between the second input signal and the second output signal through the first sub antenna 120a, and so it will be omitted herein for the sake of brevity.

Moreover, the first direction D1a can be perpendicular to the second direction D2a, and the third direction D3a can be perpendicular to the fourth direction D4a. The main purpose is to ensure that the polarization directions of the first output signal sent by the first sub antenna 120a and the second sub antenna 130a of the first antenna AT1a are vertical to each other. Similarly, it is ensured that in the second antenna AT2a, the polarization directions of the second output signals sent by the third sub antenna 140a and the fourth sub antenna 150a can be perpendicular to each other, so as to improve the transmit and receive area of the first output signal and the second output signal. The first direction D1a, the second direction D2a, the third direction D3a, and the fourth direction D4a can all be parallel to the substrate 10a, but the present disclosure is not limited to such embodiment.

In an embodiment, the first antenna AT1a does not overlap the second antenna AT2a. For example, when the first antenna AT1a and the second antenna AT2a is located at the front or the rear of the substrate 10a, the first sub antenna 120a and the second sub antenna 130a does not overlap the third sub antenna 140a and the fourth sub antenna 150a. Because the first antenna AT1a does not overlap with the second antenna AT2a, the first output signal sent by the first antenna AT1a and the second output signal sent by the second antenna AT2a will not affect each other, but the present disclosure is not limited to such embodiment.

In an embodiment, the first sub antenna length of the first sub antenna 120a and the second sub antenna length of the second sub antenna 130a are greater than the third sub antenna length of the third sub antenna 140a and the fourth sub antenna length of the fourth sub antenna 150a. For example, the first sub antenna length of the first sub antenna 120a can be defined as a length extending from the input terminal 110a (such as the input terminal 110a+) along the arc to the first terminal 121a. The second sub antenna length of the second sub antenna 130a can be defined as a length extending from the input terminal 110a (such as the input terminal 110a+) along the arc to the second terminal 131a. The third sub antenna length of the third sub antenna 140a can be defined as a length extending from the input terminal 110a (such as the input terminal 110a+) along the arc to the third terminal 141a. The fourth sub antenna length of the fourth sub antenna 150a can be defined as a length extending from the input terminal 110a (such as the input terminal 110a+) along the arc to the fourth terminal 151a, but the present disclosure is not limited to such embodiment.

Besides, the first antenna length of the first antenna AT1a can be either the length of the first sub antenna or the length of the second sub antenna, in other words, the first sub antenna length of the first sub antenna 120a is the same as the second sub antenna length of the second sub antenna 130a. Similarly, the second antenna length of the second antenna AT2a can be either the length of the third sub antenna or the length of the fourth sub antenna, in other words, the third sub antenna length of the third sub antenna 140a is the same as the fourth sub antenna length of the fourth sub antenna 150a, but the present disclosure is not limited to such embodiment.

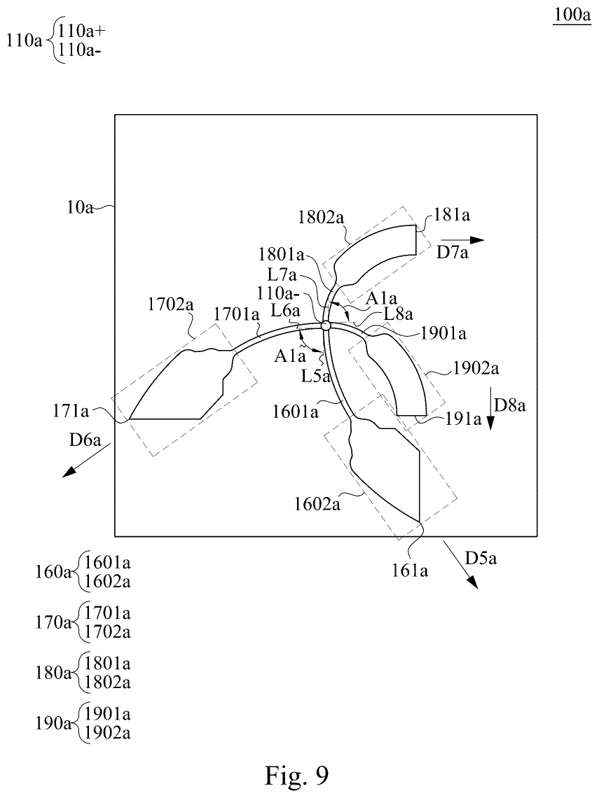

FIG. 9 is a structural diagram of a rear of a dual polarization antenna device according to an embodiment of the present disclosure. As shown in the figure, the first antenna AT1a further includes a fifth sub antenna 160a and sixth sub antenna 170a. In positional relationship, the fifth sub antenna 160a and the sixth sub antenna 170a are located at the rear of the substrate 10a. In coupling relationship, the fifth sub antenna 160a is coupled to the input terminal 110a (such as the input terminal 110a−), and the sixth sub antenna 170a is coupled to the input terminal 110a (such as the input terminal 110a−).

In operation, in an embodiment, a fifth terminal 161a of the fifth sub antenna 160a transmits and receives the first output signal along a fifth direction D5a according to the first input signal. A sixth terminal 171a of the sixth sub antenna 170a transmits and receives the first output signal along a sixth direction D6a according to the first input signal. The fifth direction D5a is parallel to the first direction D1a, and the sixth direction D6a is parallel to the second direction D2a. For example, a conversion relationship between the first input signal and the first output signal through the fifth sub antenna 160a or the sixth sub antenna 170a can be similar to the conversion relationship between the first input signal and the first output signal through the first sub antenna 120a, and so it will be omitted herein for the sake of brevity.

Moreover, the fifth direction D5a can be parallel to the first direction D1a, and the sixth direction D6a can be parallel to the second direction D2a. In other words, the fifth direction D5a can be perpendicular to the sixth direction D6a. The main purpose is to ensure that the polarization directions of the first output signal sent by the fifth sub antenna 160a and the sixth sub antenna 170a of the first antenna AT1a can be perpendicular to each other, so as to improve the transmit and receive area of the first output signal. The fifth direction D5a and the sixth direction D6a can all be parallel to the substrate 10a, but the present disclosure is not limited to such embodiment.

Referring to FIG. 7 and FIG. 9, in an embodiment, the second antenna AT2a further includes a seventh sub antenna 180a and an eighth sub antenna 190a. In positional relationship, the seventh sub antenna 180a and the eighth sub antenna 190a are located at the rear of the substrate 10a. In coupling relationship, the seventh sub antenna 180a is coupled to the input terminal 110a (such as the input terminal 110a−), the eighth sub antenna 190a is coupled to the input terminal 110a (such as the input terminal 110a−).

In operation, in an embodiment, a seventh terminal 181a of the seventh sub antenna 180a transmits and receives the second output signal along a seventh direction D7a according to the second input signal. An eighth terminal 191a of the eighth sub antenna 190a transmits and receives the second output signal along an eighth direction D8a according to the second input signal. The seventh direction D7a is parallel to the third direction D3a, and the eighth direction D8a is parallel to the fourth direction D4a. For example, a conversion relationship between the second input signal and the second output signal through the seventh sub antenna 180a or the eighth sub antenna 190a can be similar to the conversion relationship between the first input signal and the first output signal through the first sub antenna 120a, and so it will be omitted herein for the sake of brevity.

Besides, the seventh direction D7a can be parallel to the third direction D3a, and the eighth direction D8a can be parallel to the fourth direction D4a. In other words, the seventh direction D7a can be perpendicular to the eighth direction D8a. The main purpose is to ensure that the polarization directions of the second output signal sent by the seventh sub antenna 180a and the eighth sub antenna 190a of the second antenna AT2a can be perpendicular to each other, so as to improve the transmit and receive area of the second output signal. The seventh direction D7a and the eighth direction D8a can all be parallel to the substrate 10a, but the present disclosure is not limited to such embodiment.

Referring to FIG. 7, in one embodiment, a first sub antenna length of the first sub antenna 120a, a second sub antenna length of a the second sub antenna 130a, a fifth sub antenna length of the fifth sub antenna 160a, and a sixth sub antenna length of the sixth sub antenna 170a are the same, and a third sub antenna length of the third sub antenna 140a, a fourth sub antenna length of the fourth sub antenna 150a, a seventh sub antenna length of the seventh sub antenna 180a, and an eighth sub antenna length of the eighth sub antenna 190a are the same. For example, in the first antenna AT1a, the first sub antenna length, the second sub antenna length, the fifth sub antenna length, and the sixth sub antenna length are the same. In the second antenna AT2a, the third sub antenna length, the fourth sub antenna length, the seventh sub antenna length, and the eighth sub antenna length are the same, and follow the following formula:

$$cl = \frac{1}{4} λ . \qquad formula 1$$

$$λ = \frac{c}{f} . \qquad formula 2$$

In the above formula 1, cl is the antenna length (cm), and λ is a wavelength (cm). In the above formula 2, λ is the wavelength (cm), c is a speed of light (m/s), f is a frequency (Hz).

A Table 2 can be obtained according to the above formula 1 and formula 2, as shown below.

TABLE 2

| | 2 G antenna | 5 G antenna | 2.4 G antenna |
|---|---|---|---|
| the speed of light (m/s) | 3 × 10⁸ | 3 × 10⁸ | 3 × 10⁸ |
| the frequency (Hz) | 2 × 10⁹ | 5 × 10⁹ | 2.4 × 10⁹ |
| the wavelength (cm) | 15 | 6 | 12.5 |
| the antenna length (cm) | 3.75 | 1.5 | 3.125 |

Referring to the Table 2, for example, when the first output signal transmitted and received by the first antenna AT1a is 2G (Hz), the antenna length can be 3.75 (cm). Therefore, the first sub antenna length, the second sub antenna length, the fifth sub antenna length, and the sixth sub antenna length can be 3.75 (cm). Similarly, when the second output signal transmitted and received by the second antenna AT2a is 5G (Hz), the antenna length can be 1.5 (cm). Therefore, the third sub antenna length, the fourth sub antenna length, the seventh sub antenna length, and the eighth sub antenna length can be such as 1.5 (cm), but the present disclosure is not limited to such embodiment.

Referring to FIG. 8 and FIG. 9, in an embodiment, the first sub antenna 120a includes a first arc wire 1201a and a first transmit and receive component 1202a, and the first terminal 121a of the first transmit and receive component 1202a transmits and receives the first output signal along the first direction D1a. The second sub antenna 130a includes a second arc wire 1301a and a second transmit and receive component 1302a, and the second terminal 131a of the second transmit and receive component 1302a transmits and receives the first output signal along the second direction D2a. The third sub antenna 140a includes a third arc wire 1401a and a third transmit and receive component 1402a, and the third terminal 141a of the third transmit and receive component 1402a transmits and receives the second output signal along the third direction D3a. The fourth sub antenna 150a includes a fourth arc wire 1501a and a fourth transmit and receive component 1502a, and the fourth terminal 151a of the fourth transmit and receive component 1502a transmits and receives the second output signal along the fourth direction D4a.

For example, the first terminal 121a of the first transmit and receive component 1202a can be the first terminal 121a (as shown in FIG. 7) of the first sub antenna 120a, the second terminal 131a of the second transmit and receive component 1302a can be the second terminal 131a (as shown in FIG. 7) of the second sub antenna 130a, the third terminal 141a of the third transmit and receive component 1402a can be the third terminal 141a (as shown in FIG. 7) of the third sub antenna 140a, and the fourth terminal 151a of the fourth transmit and receive component 1502a can be the fourth terminal 151a (as shown in FIG. 7) of the fourth sub antenna 150a, but the present disclosure is not limited to such embodiment.

Referring to FIG. 8, in an embodiment, the input terminal 110a (such as the input terminal 110a+) forms a first tangent line L1a along the first arc wire 1201a, the input terminal 110a (such as the input terminal 110a+) forms a second tangent line L2a along the second arc wire 1301a, and the first tangent line L1a and the second tangent line L2a intersect each other at an angle A1a. The input terminal 110a (such as the input terminal 110a+) forms a third tangent line L3a along the third arc wire 1401a, the input terminal 110a (such as the input terminal 110a+) forms a fourth tangent line L4a along the fourth arc wire 1501a, and the third tangent line L3a and the fourth tangent line L4a intersect each other at the angle A1a. For example, the first tangent line L1a and the second tangent L2a can intersect each other at the angle A1a, the third tangent line L3a and the fourth tangent line L4a can intersect each other about at angle A1a, and the angle A1a can be 90 degrees. The main purpose is to ensure that the polarization directions of the first output signal sent by the first sub antenna 120a and the second sub antenna 130a of the first antenna AT1a can be perpendicular to each other. Similarly, it is ensured that in the second antenna AT2a, the polarization directions of the second output signal sent by the third sub antenna 140a and the fourth sub antenna 150a can be perpendicular to each other, so as to improve the transmit and receive area of the first output signal and the second output signal, but the present disclosure is not limited to such embodiment.

Referring to FIG. 9, the fifth sub antenna 160a includes a fifth arc wire 1601a and a fifth transmit and receive component 1602a, and the fifth terminal 161a of the fifth transmit and receive component 1602a transmits and receives the first output signal along the fifth direction D5a. The sixth sub antenna 170a includes a sixth arc wire 1701a and a sixth transmit and receive component 1702a, and the sixth terminal 171a of the sixth transmit and receive component 1702a transmits and receives the first output signal along the sixth direction D6a. The seventh sub antenna 180a includes a seventh arc wire 1801a and a seventh transmit and receive component 1802a, and the seventh terminal 181a of the seventh transmit and receive component 1802a transmits and receives the second output signal along the seventh direction D7a. The eighth sub antenna 190a includes an eighth arc wire 1901a and an eighth transmit and receive component 1902a, and the eighth terminal 191a of the eighth transmit and receive component 1902a transmits and receives the second output signal along the eighth direction D8a.

For example, the fifth terminal 161a of the fifth transmit and receive component 1602a can be the fifth terminal 161a (as shown in FIG. 7) of the fifth sub antenna 160a, the sixth terminal 171a of the sixth transmit and receive component 1702a can be the sixth terminal 171a (as shown in FIG. 7) of the sixth sub antenna 170a, the seventh terminal 181a of the seventh transmit and receive component 1802a can be the seventh terminal 181a (as shown in FIG. 7) of the seventh sub antenna 180a, and the eighth terminal 191a of the eighth transmit and receive component 1902a can be the eighth terminal 191a (as shown in FIG. 7) of the eighth sub antenna 190a, but the present disclosure is not limited to such embodiment.

In an embodiment, the input terminal 110a (such as the input terminal 110a−) forms a fifth tangent line L5a along the fifth arc wire 1601a, the input terminal 110a (such as the input terminal 110a−) forms a sixth tangent line L6a along the sixth arc wire 1701a, and the fifth tangent line L5a and the sixth tangent line L6a intersect each other at the angle A1a. The input terminal 110a (such as the input terminal 110a−) forms a seventh tangent line L7a along the seventh arc wire 1801a, the input terminal 110a (such as the input terminal 110a−) forms an eighth tangent line L8a along the eighth arc wire 1901a, and the seventh tangent line L7a and the eighth tangent line L8a intersect each other at the angle A1a. For example, the fifth tangent line L5a and the sixth tangent line La can intersect each other at the angle A1a, the seventh tangent line L7a and the eighth tangent line L8a can intersect each other at the angle A1a, and the angle A1a can be 90 degrees. The main purpose is to ensure that the polarization directions of the first output signal sent by the fifth sub antenna 160a and the sixth sub antenna 170a of the first antenna AT1a can be perpendicular to each other. Similarly, it is ensured that in the second antenna AT2a, the polarization directions of the second output signals sent by the seventh sub antenna 180a and the eighth sub antenna 190a can be perpendicular to each other, so as to improve the transmit and receive area of the first output signal and the second output signal, but the present disclosure is not limited to such embodiment.

In an embodiment, angle A1a includes the 90 degree angle. For example, the angle A1a can be 70, 80, or 90 degrees, but the present disclosure is not limited to the embodiment. In some embodiments, the angle A1a (that is, the best implementation angle) in the present disclosure can be 90 degrees, but the present disclosure is not limited to such embodiment.

Referring to FIG. 8 and FIG. 9, in an embodiment, the first sub antenna length of the first sub antenna 120a can be defined as a length extending from the input terminal 110a (such as the input terminal 110a+) along the first arc wire 1201a to the first terminal 121a. The second sub antenna length of the second sub antenna 130a can be defined as a length extending from the input terminal 110a (such as the input terminal 110a+) along the second arc wire 1301a to the second terminal 131a. The third sub antenna length of the third sub antenna 140a can be defined as a length extending from the input terminal 110a (such as the input terminal 110a+) along the third arc wire 1401a to the third terminal 141a. The fourth sub antenna length of the fourth sub antenna 150a can be defined as a length extending from the input terminal 110a (such as the input terminal 110a+) along the fourth arc wire 1501a to the fourth terminal 151a, but the present disclosure is not limited to such embodiment.

In an embodiment, the fifth sub antenna length of the fifth sub antenna 160a can be defined as a length extending from the input terminal 110a (such as the input terminal 110a−) along the fifth arc wire 1601a to the fifth terminal 161a. The sixth sub antenna length of the sixth sub antenna 170a can be defined as a length extending from the input terminal 110a (such as the input terminal 110a−) along the sixth arc wire 1701a to the sixth terminal 171a. The seventh sub antenna length of the seventh sub antenna 180a can be defined as a length extending from the input terminal 110a (such as the input terminal 110a−) along the seventh arc wire 1801a to the seventh terminal 181a. The eighth sub antenna length of the eighth sub antenna 190a can be defined as a length extending from the input terminal 110a (such as the input terminal 110a−) along the eighth arc wire 1901a to the eighth terminal 191a, but the present disclosure is not limited to such embodiment.

It can be seen from the above embodiments that the present disclosure has the following advantages. The dual polarization antenna device shown in the embodiment of the present disclosure can achieve the effect of outputting the plurality of output signals through the plurality of antenna structures.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A dual polarization antenna device, comprising:
an input terminal, configured to receive a first input signal and a second input signal;
a first antenna, comprising:
a first sub antenna, located at a front of a substrate and coupled to the input terminal, wherein a first terminal of the first sub antenna transmits and receives a first output signal along a first direction according to the first input signal;
a second sub antenna, located at the front of the substrate and coupled to the input terminal, wherein a second terminal of the second sub antenna transmits and receives the first output signal along a second direction according to the first input signal;
a second antenna, comprising:
a third sub antenna, located at the front of the substrate and coupled to the input terminal, wherein a third terminal of the third sub antenna transmits and receives a second output signal along a third direction according to the second input signal; and
a fourth sub antenna, located at the front of the substrate and coupled to the input terminal, wherein a fourth terminal of the fourth sub antenna transmits and receives the second output signal along a fourth direction according to the second input signal, wherein the first direction is perpendicular to the second direction, and the third direction is perpendicular to the fourth direction.

2. The dual polarization antenna device of claim 1, wherein the first antenna does not overlap the second antenna.

3. The dual polarization antenna device of claim 1, wherein a first antenna length of one of the first sub antenna and the second sub antenna greater than a second antenna length of one of the third sub antenna and the fourth sub antenna.

4. The dual polarization antenna device of claim 3, wherein the first antenna further comprises:
a fifth sub antenna, located at a rear of the substrate and coupled to the input terminal, wherein a fifth terminal of the fifth sub antenna transmits and receives the first output signal along a fifth direction according to the first input signal; and
a sixth sub antenna, located at the rear of the substrate and coupled to the input terminal, wherein a sixth terminal of the sixth sub antenna transmits and receives the first output signal along a sixth direction according to the first input signal, wherein the fifth direction is parallel to the first direction, and the sixth direction is parallel to the second direction.

5. The dual polarization antenna device of claim 4, wherein the second antenna further comprises:
a seventh sub antenna, located at the rear of the substrate and coupled to the input terminal, wherein a seventh terminal of the seventh sub antenna transmits and receives the second output signal along a seventh direction according to the second input signal; and
an eighth sub antenna, located at the rear of the substrate and coupled to the input terminal, wherein an eighth terminal of the eighth sub antenna transmits and receives the second output signal along an eighth direction according to the second input signal, wherein the seventh direction is parallel to the third direction, and the eighth direction is parallel to the fourth direction.

6. The dual polarization antenna device of claim 5, wherein a first sub antenna length of the first sub antenna, a second sub antenna length of a the second sub antenna, a fifth sub antenna length of the fifth sub antenna, and a sixth sub antenna length of the sixth sub antenna are the same, and a third sub antenna length of the third sub antenna, a fourth sub antenna length of the fourth sub antenna, a seventh sub antenna length of the seventh sub antenna, and an eighth sub antenna length of the eighth sub antenna are the same.

7. The dual polarization antenna device of claim 5, wherein the first sub antenna comprises a first arc wire and a first transmit and receive component, and the first terminal of the first transmit and receive component transmits and receives the first output signal along the first direction, wherein the second sub antenna comprises a second arc wire and a second transmit and receive component, and the second terminal of the second transmit and receive component transmits and receives the first output signal along the second direction, wherein the third sub antenna comprises a third arc wire and a third transmit and receive component, and the third terminal of the third transmit and receive component transmits and receives the second output signal along the third direction, wherein the fourth sub antenna comprises a fourth arc wire and a fourth transmit and receive component, and the fourth terminal of the fourth transmit and receive component transmits and receives the second output signal along the fourth direction.

8. The dual polarization antenna device of claim 7, wherein the input terminal forms a first tangent line along the first arc wire, the input terminal forms a second tangent line along the second arc wire, and the first tangent line and the second tangent line intersect each other at an angle, wherein the input terminal forms a third tangent line along the third arc wire, the input terminal forms a fourth tangent line along the fourth arc wire, and the third tangent line and the fourth tangent line intersect each other at the angle.

9. The dual polarization antenna device of claim 5, wherein the fifth sub antenna comprises a fifth arc wire and a fifth transmit and receive component, and the fifth terminal of the fifth transmit and receive component transmits and receives the first output signal along the fifth direction, wherein the sixth sub antenna comprises a sixth arc wire and a sixth transmit and receive component, and the sixth terminal of the sixth transmit and receive component transmits and receives the first output signal along the second direction, wherein the seventh sub antenna comprises a seventh arc wire and a seventh transmit and receive component, and the seventh terminal of the seventh transmit and receive component transmits and receives the second output signal along the seventh direction, wherein the eighth sub antenna comprises an eighth arc wire and an eighth transmit and receive component, and the eighth terminal of the eighth transmit and receive component transmits and receives the second output signal along the eighth direction.

10. The dual polarization antenna device of claim 9, wherein the input terminal forms a fifth tangent line along the fifth arc wire, the input terminal forms a sixth tangent line along the sixth arc wire, and the fifth tangent line and the sixth tangent line intersect each other at an angle, wherein the input terminal forms a seventh tangent line along the seventh arc wire, the input terminal forms an eighth tangent line along the eighth arc wire, and the seventh tangent line and the eighth tangent line intersect each other at the angle.
